(19) United States
(12) Patent Application Publication
(10) Pub. No.: US 2015/0321468 A1
(43) Pub. Date: Nov. 12, 2015

(54) Ink Jet Recording Apparatus

(71) Applicant: Hitachi Industrial Equipment Systems Co., Ltd., Tokyo (JP)

(72) Inventors: Masato IKEGAWA, Tokyo (JP); Eiji ISHII, Tokyo (JP); Nobuhiro HARADA, Tokyo (JP); Akira MIYAO, Tokyo (JP)

(21) Appl. No.: 14/595,368

(22) Filed: Jan. 13, 2015

(30) Foreign Application Priority Data
May 8, 2014 (JP) 2014-096449

(51) Int. Cl. B41J 2/02

(52) U.S. Cl. CPC B41J 2/02

(57) ABSTRACT

An ink jet recording apparatus that can perform high velocity printing without printing distortion is realized. In a continuous discharge type ink jet recording apparatus, a unit that suppresses a velocity in the vicinity of a center axis is disposed in a unit that injects ink droplets in which because a velocity in an outer periphery is higher than that in a center of a discharged liquid column, a velocity on a surface of the liquid column becomes quickly high, and a capillary wave that propagates on a surface of the liquid column in a travel direction is quickly amplified because the velocity becomes quickly a velocity suitable for droplet breakup, the droplet breakup is quickly generated, and the droplet breakup is surely generated within a charging electrode located next to the nozzle. As a result, an ink jet recording apparatus stable in printing quality performance is provided.

### BACKGROUND OF THE INVENTION

1. Technical Field

The present invention relates to an ink jet recording apparatus.

2. Description of the Related Art

Among ink jet recording apparatuses, a continuous discharge type inkjet recording apparatus is a highly stable droplet discharge device having a high maintainability and a high reliability as compared with an on-demand type ink jet recording apparatus used in a domestic or office printer. Therefore, the continuous discharge type ink jet recording apparatuses are used on many production lines for printing on various types of products such as cans, bottles, packages, and food packaging.

For that reason, the continuous discharge type ink jet recording apparatus can be also applied to a manufacturing device for electronic equipment requiring function ink coating or pattering using liquid which requires high reliability, high maintenance, and high stability. Also, the continuous discharge type ink jet recording apparatus can be also used as three-dimensional molding, for example, a 3D printer.

In the continuous discharge type ink jet recording apparatus, liquid (ink) stored in an ink tank is pressurized by a pump, and is ejected continuously from a fine nozzle. Then, the liquid is vibrated while being excited by a piezoelectric element or the like, the ejected liquid is allowed to fluctuate, and an ink column to be discharged is cut off to jet fine droplets of ink. In this situation, a charging electrode is arranged in the vicinity of a droplet formation position at which the ink column is cut off, and an electric field is applied to the fine droplets of ink to charge formed droplets.

A flying direction of the charged droplets is controlled according to the presence/absence of charge, or the magnitude of charge (charge amount) under an electric field generated by applying a voltage to a defection electrode arranged at a downstream position of the charging electrode (deflection process).

This deflection process is generally divided into two systems including a multi-deflection system and a binary-deflection system. In any of those systems, since the amount of charging the discharged liquid (ink) is controlled and used for the deflection of liquid, it is not necessary to perform the discharge control of droplets drop by drop, and the configuration of the device becomes simple. Also, since the droplets are discharged in succession, nozzle jams are unlikely to occur, and high reliability can be ensured.

In most of the continuous discharge type ink jet recording apparatuses, as described above, the liquid is vibrated with the excitation by the piezoelectric element or the like, and the ink column to be discharged is cut off. If a distance from a nozzle exit to the cutting of the liquid column (breakup distance) is longer, a length of an ink jet head becomes longer, or the liquid cannot be cut off into the droplets within the charging electrode, and the sufficient amount of charge cannot be given the liquid, resulting in a problem that print distortion increases. In particular, the ink mixed inclusions such as polymers or surfactants suffers from such a problem that the breakup distance increases.

How to cut off the liquid column will be described. If the liquid is excited at a certain frequency by the piezoelectric element or the like, and vibrated, a capillary wave having the same frequency is generated on a surface of the liquid column of a laminar flow out of the nozzle, and the amplitude is amplified more as the capillary wave travels together with the liquid column. When the capillary wave reaches a center axis of the liquid column, the liquid column is cut off, and the droplets having an equal diameter are aligned and flied. Regarding the droplet separation phenomenon, Plateau (1856 Years) has proved that if a wave number k (=2π/wavelength) of the capillary wave and a nozzle radius “a” satisfy a condition of k·a<1 (k·a is called “droplet formation constant”), a constricted amplitude grows and the liquid is broken up into droplets. Thereafter, Rayleigh (1879 years, Rayleigh, L., “On the Instability of Jets,” Proc. London Math. Soc. 10, pp. 4-13.) has proved that an amplitude growth rate becomes largest when k·a=1/√2 is satisfied on the basis of the infinitesimal deformation theory by cylindrical model. Because the capillary wave travels on the surface of the liquid column, the wave number k becomes k=2πf/U on the basis of a flow velocity U of the liquid column, and an excitation frequency f. Then, an optimum velocity of the liquid column becomes U=2√2πa·f. In most of the continuous discharge type ink jet recording apparatuses, the velocity of ink jet is set to about this value. However, in fact, because the flow rate is zero on a wall surface within the nozzle, it takes time until the surface velocity of the ink jet reaches a given velocity U after leaving the nozzle. Under the circumstance, the breakup distance becomes longer, a distance to a print body becomes longer, and the amount of charging particles becomes insufficient without cutting off the liquid into the droplets within the charging electrode, resulting in a problem that printing failure occurs.

JP-A-53-77626 discloses that in order to remove air bubbles within the nozzle, a filter is inserted into the nozzle of the ink jet, and a helical groove is formed in the filter to generate a swirling flow, or a large hole is opened in an outer periphery of the filter to produce turbulence.

Also, JP-A-2000-190508 discloses a continuous discharge type ink jet recording apparatus in which asymmetric heat is applied to a nozzle exit to deflect the direction of the jet.

### SUMMARY OF THE INVENTION

However, in the swirling flow generation structure using the spiral passage, the disturbance using an outer peripheral hole, or asymmetric heating in the nozzle exit disclosed in the above related art, the breakup distance of the liquid jet cannot be reduced.

Up to now, because various materials such as polymers or surfactants are mixed into the ink in order for various printing purposes, droplet breakup is late, and the liquid is not broken up within the charging electrode. As a result, the sufficient amount of charge is not added to the droplets, resulting in a problem that printing distortion increases.

Under the circumstances, the present invention has been made to solve the above problem with droplet generation in the continuous inkjet recording apparatus, and aims at providing an ink jet recording apparatus for high velocity printing without print distortion.

According to the present invention, for the purpose of achieving the above-mentioned object, there is provided a continuous discharge type ink jet recording apparatus for recording characters or the like on an object to be recorded which moves in a direction substantially perpendicular to a deflection direction, including a unit that injects ink droplets, a unit that generates a recording signal corresponding to recording information, a unit that charges the ink droplets on the basis of the recording signal, and a unit that deflects a flying direction of the charged ink droplets, in which a unit that suppressing a velocity in the vicinity of a center axis is disposed in a unit that injects ink droplets in which because a velocity in an outer periphery is higher than that in a center of a discharged liquid column, a velocity on a surface of the liquid column becomes quickly high, and a capillary wave that propagates on a surface of the liquid column in a travel direction is quickly amplified because the velocity become quickly a velocity suitable for droplet breakup, the droplet breakup is quickly generated, and the droplet breakup is surely generated within a charging electrode located next to the nozzle. As a result, an inkjet recording apparatus stable in printing quality performance is provided.

Also, the present invention can be applied to a case in which the droplets are not charged in the ink jet recording apparatus described above.

According to the present invention, an ink jet recording apparatus and method that can perform high velocity printing without printing distortion can be realized.

### BRIEF DESCRIPTION OF THE DRAWINGS

FIG. 1 is a configuration diagram illustrating a main portion of a continuous discharge type ink jet recording apparatus according to a first embodiment of the present invention;

FIG. 2 is a configuration diagram illustrating a main portion of the continuous discharge type ink jet recording apparatus according to the first embodiment of the present invention;

FIG. 3 is an illustrative diagram illustrating the details of the continuous discharge type ink jet recording apparatus according to the first embodiment of the present invention;

FIG. 4 is a configuration diagram illustrating a main portion of the continuous discharge type ink jet recording apparatus according to the first embodiment of the present invention;

FIG. 5 is a configuration diagram illustrating a main portion of a continuous discharge type ink jet recording apparatus according to a second embodiment of the present invention;

FIG. 6 is a configuration diagram illustrating a main portion of the continuous discharge type ink jet recording apparatus according to the third embodiment of the present invention;

FIG. 7 is an overall configuration diagram illustrating an ink jet recording apparatus according to the present invention;

FIG. 8 is a configuration diagram of a main portion in an existing example different from the present invention for comparison with the present invention;

FIG. 9 is an illustrative diagram of advantages of a main portion in an existing example different from the present invention for comparison with the present invention; and

FIG. 10 is a configuration diagram of a main portion in a continuous discharge type ink jet recording apparatus for 3D printing according to a fourth embodiment of the present invention.

### DETAILED DESCRIPTION OF THE INVENTION

Hereinafter, embodiments of the present invention will be described in detail with reference to the accompanying drawings.

### EMBODIMENTS

First, a description will be given of an overall configuration of an ink jet recording apparatus according to the present invention.

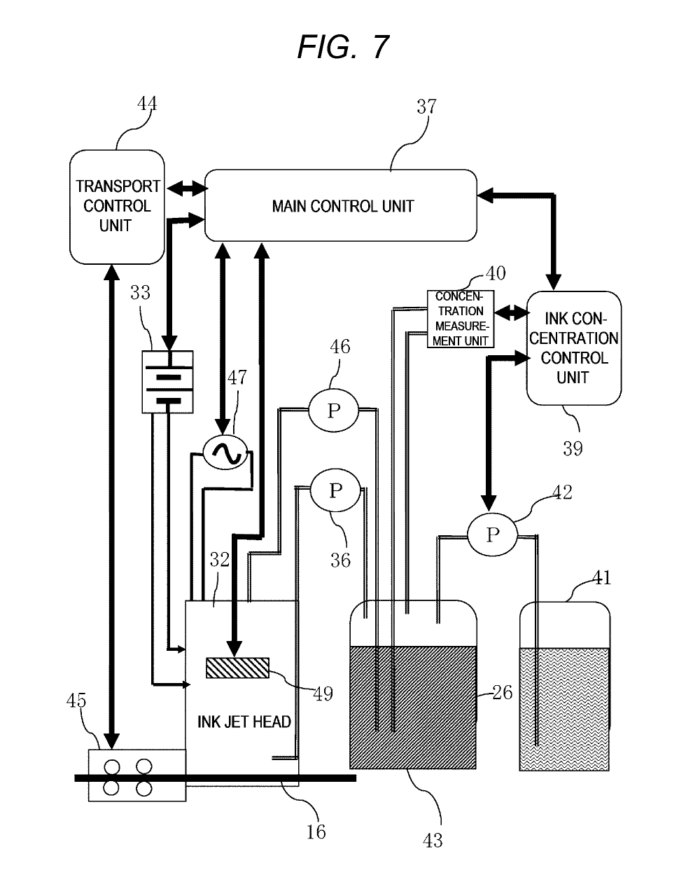

FIG. 7 is an overall configuration diagram illustrating an ink jet recording apparatus according to the present invention. Referring to FIG. 7, an ink jet recording apparatus includes an ink jet drive unit, an ink concentration control unit, and a recording medium transport control unit.

The ink jet drive unit includes an ink jet head 32, a liquid reservoir 43, an AC power supply 47 which supplies AC voltage to a piezoelectric element within the inkjet head 32, a control voltage power supply 33 which applies a voltage to a charging electrode for supplying electric charge to respective droplets, and a deflection electrode for deflecting the droplets, pumps 46 and 36 which perform supply and recovery of the liquid with respect to the ink jet head 32, and a main control unit 37 that controls the operation of the respective units.

Also, the ink concentration control unit is configured to regulate the concentration of the liquid within the liquid reservoir 43, which is supplied to the ink jet head 32. Specifically, the ink concentration control unit includes a concentration measurement unit 40 that is a unit for measuring a liquid concentration within the liquid reservoir 43, a solvent storage tank 41 for storing a liquid solvent used to dilute the liquid in the liquid reservoir 43, a supply pump 42 for supplying the solvent in the solvent storage tank 41 to the liquid reservoir 43 of the ink jet drive unit, and an ink concentration control unit 39 for controlling those units.

Also, the recording medium transport control unit includes a recording medium transport mechanism 45, and a transport control unit 44.

Then, in the above configuration, upon receiving pattern data (not shown) to be recorded from an external, the main control unit 37 of the ink jet drive unit controls the liquid supply/recovery pumps 46 and 36, the piezoelectric element driving AC power supply 47, and the control voltage power supply 33 that applies a charging voltage/deflection voltage, to thereby output a charging electrode signal voltage to a charging electrode part (not shown in this example), and a deflection electrode signal voltage to a deflection electrode (not shown in this example), respectively, according to the pattern data to be recorded. With the above operation, the main control unit 37 controls the discharge of the liquid (ink).

Also, the main control unit 37 of the ink jet drive unit communicates with the transport control unit 44 of the recording medium transport control unit to handle a print body 16. Further, the main control unit 37 of the ink jet drive unit communicates with the ink concentration control unit 39 of the ink concentration control unit, confirms that the liquid concentration within the liquid reservoir 43 is a given concentration, and also controls the liquid with the given concentration to be supplied to the ink jet head 32.

Alternatively, within the ink jet head 32, a droplet shape observation unit 49 is located in an ink formation region, information obtained by the droplet shape observation unit 49 is fed back to the main control unit 37, and a proper input value calculated on the basis of the fed-back information is input to the piezoelectric element, to thereby stabilize the uniform discharge of the ink.

### First Embodiment

An embodiment of the present invention as described below is applied to a continuous discharge type ink jet recording apparatus among the ink jet recording apparatus illustrated in FIG. 7.

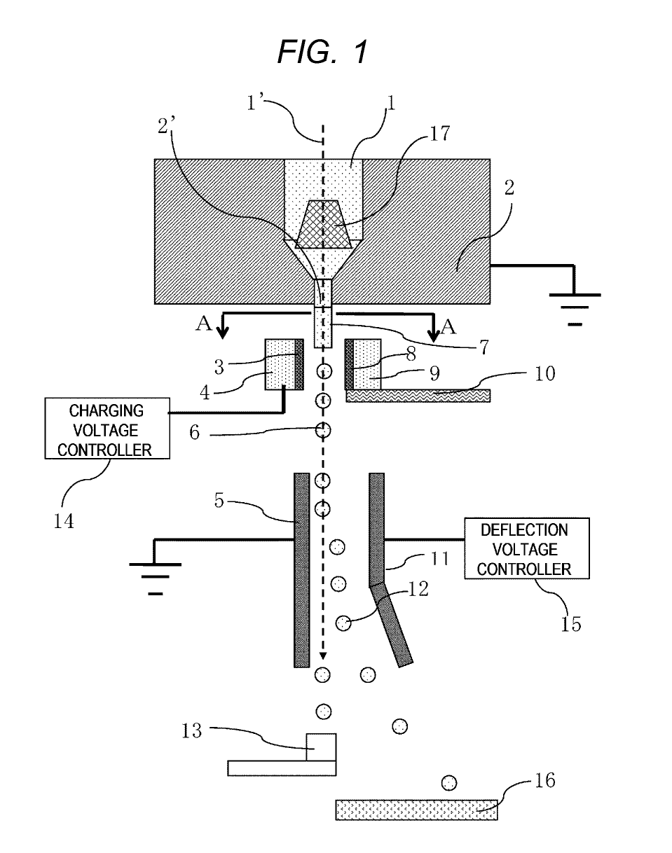

A description will be given of a general structure of a nozzle in an ink jet heat in the continuous discharge type ink jet recording apparatus (or continuous ink jet recording apparatus) according to the first embodiment of the present invention with reference to FIGS. 1, 2, 3, and 4.

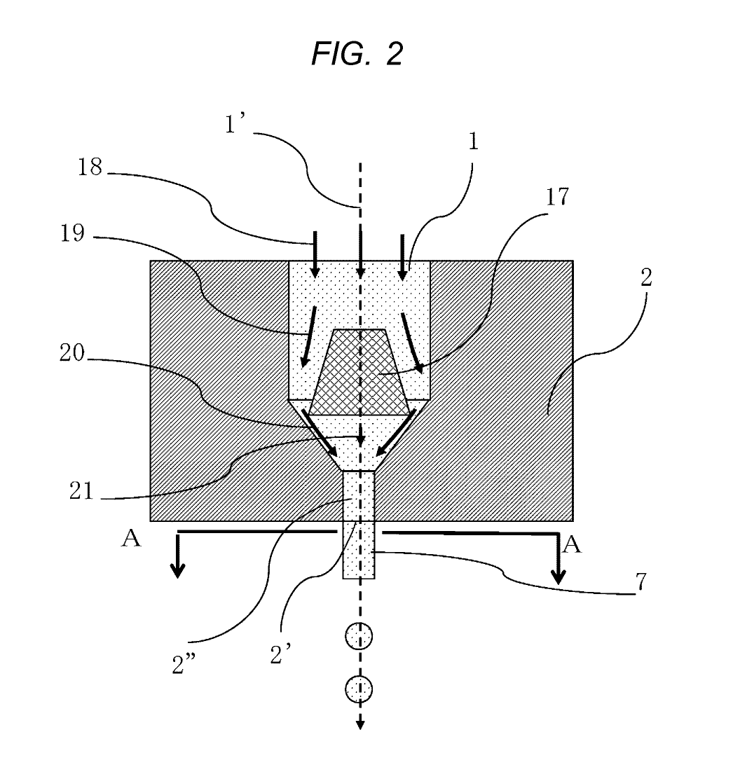

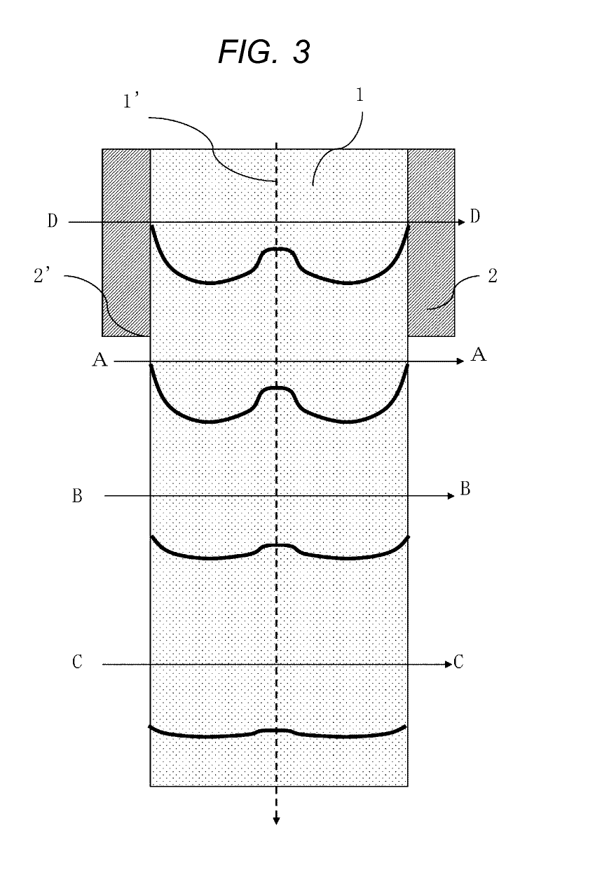

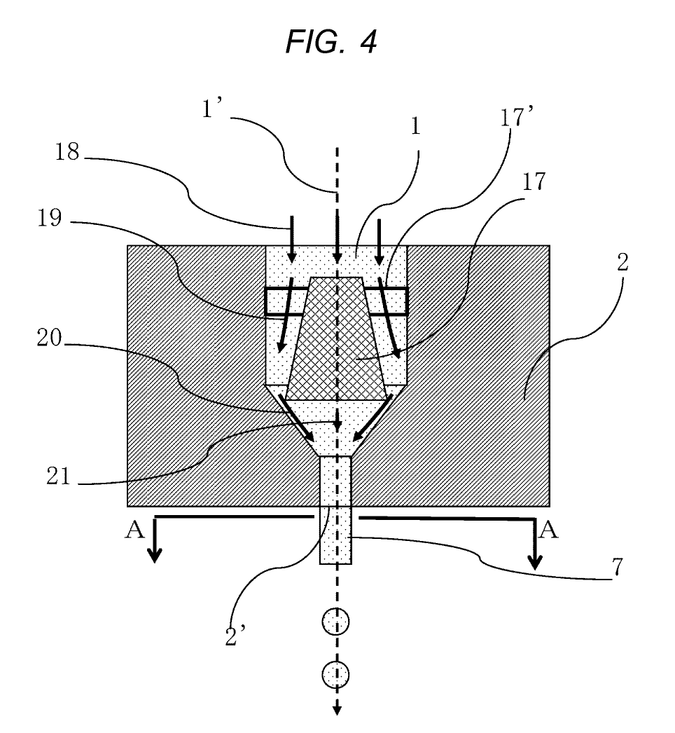

FIG. 1 is a configuration diagram of a main portion of the first embodiment of the present invention, which is a diagram illustrating an internal configuration of the inkjet head 32 in FIG. 7. FIG. 2 is a configuration diagram of a main portion of a nozzle head 2, and FIG. 3 is an illustrative diagram of the details of a change in a velocity distribution of ink in a traveling direction, which is close to a cross-section A-A in the vicinity of an exit of an ink chamber 1 in FIG. 1. FIG. 4 is a configuration diagram illustrating a main portion of the first embodiment of the present invention.

In FIG. 1, the inkjet head of the continuous discharge type ink jet recording apparatus according to the present invention includes the nozzle head 2 with the ink chamber 1 for ejecting droplets, charging electrodes 3 and 8 for charging formed droplets, individually, a pair of deflection electrodes 5 and 11 for deflecting the charged droplets by an electric field, and a gutter 13 that recovers the droplets for the purpose of reusing the droplets not used for printing. The deflection electrodes 5 and 11 are disposed to have opposite surfaces parallel to each other. An axis vicinity velocity suppression unit 17 for suppressing a velocity in the vicinity of a center axis (ink incident line 1′) is located within the ink chamber 1.

In the configuration shown in FIG. 1, capillary waves are attracted to a surface of a liquid column 7 discharged from the nozzle of the nozzle head 2 due to vibration applied from an upper portion of the ink chamber 1 in the nozzle head 2. The amplitude of the capillary waves increases, and the liquid column 7 is cut off as droplets to form a droplet string as illustrated in the figure. An overall housing of the nozzle head 2 is grounded. Then, the formed droplets are negatively charged by the charging electrodes 3 and 8 which are formed on charging electrode substrates 4 and 9, and arranged in proximity to each other in parallel to a flying direction of the droplets.

In this example, the charging electrodes 3 and 8 are configured to charge the individual droplets according to an intended printing form by applying an arbitrary voltage to the droplets by a charging voltage controller 14 at an arbitrary timing.

In this situation, a cutting point (droplets are formed by cutting off the liquid column) of the liquid column 7 is positioned on the charging electrodes 3 and 8 disposed in correspondence with the droplet string. Also, it is preferable that the charging electrodes 3 and 8 are arranged so that the droplet string passes through substantially a center in a width direction (direction perpendicular to a paper plane of the figure) thereof.

So-called deflection electrodes that develop a deflection field for deflecting charged droplets 12 in an arbitrary direction by an electric field are located below (below the charging electrodes 3 and 8) in the ink flying direction in a charging process. Those deflection electrodes are configured by the ground deflection electrode (first deflection electrode) 5 and the high voltage deflection electrode (second deflection electrode) 11, and arranged so that those deflection electrodes face each other in parallel. The electric lines of force are perpendicular to the surfaces of the deflection electrodes 5 and 11, are formed in parallel to each other.

The droplets that have passed through the charging electrodes 3 and 8 (including charged droplets and uncharged droplets) fly within a region in which the deflection field is formed, as a result of which the charged droplets 12 are deflected in a direction of approaching the electrode 11 having an opposite sign to that of the charge due to an influence of the deflection field, and landed on the print body 16 to form a print pattern. Because the droplets having a large amount of charge approach a positive electrode, the ink incident line 1′ is set to a position close to the surface of the grounded deflection electrode 5 for printing large characters.

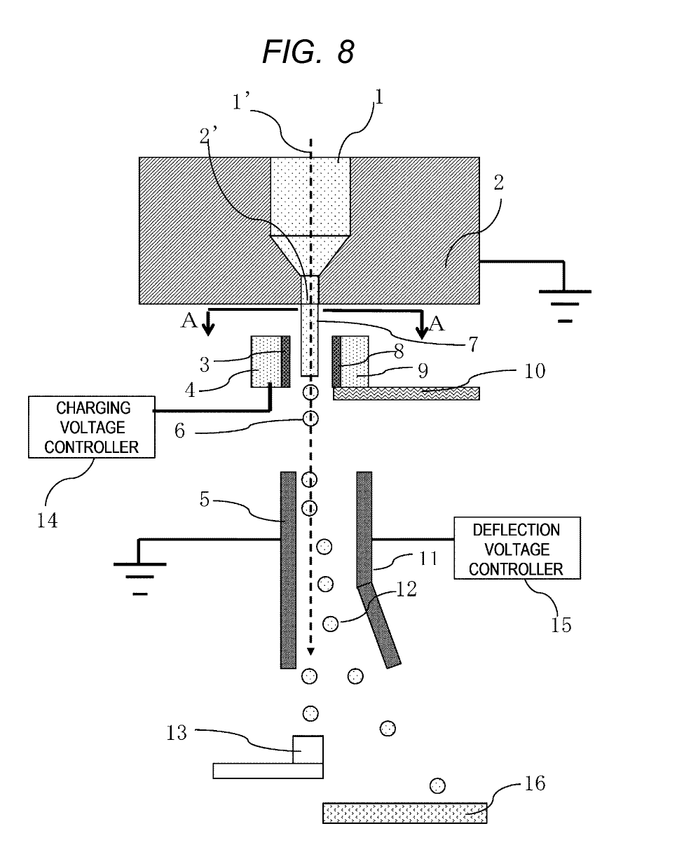

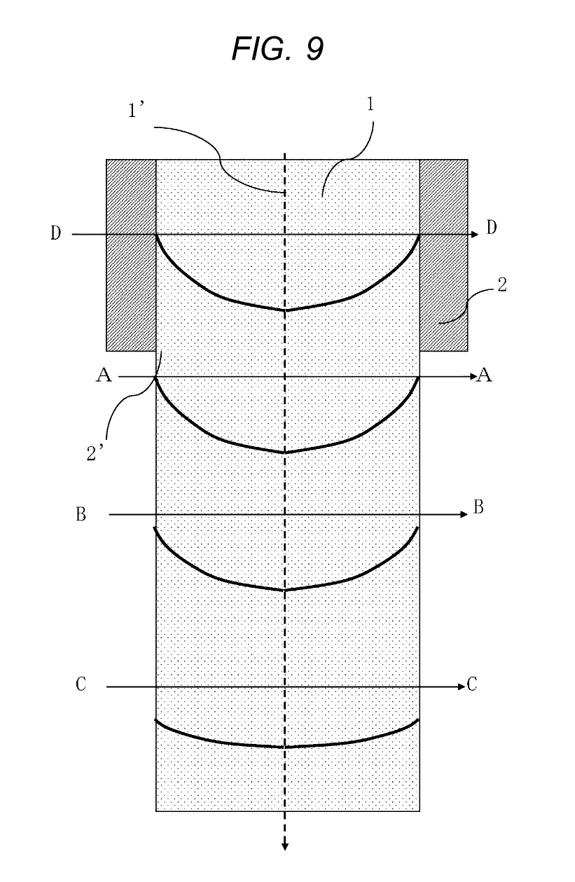

FIG. 8 illustrates an example (existing example) different from the present invention, and FIG. 9 is a detailed illustrative diagram illustrating a change in a velocity distribution of ink in the vicinity of the exit of the ink chamber 1 in FIG. 8 in a traveling direction, which is a diagram illustrating a comparative example for comparison with the present invention. As illustrated in FIG. 8, the ink chamber 1 has a through hole an inner diameter of which is sequentially reduced toward the exit. As generally known, a velocity of the fluid is zero on an inner wall of the hole, and a velocity distribution within the hole has a parabolic shape having a maximum value on a center axis as indicated by a cross section D in FIG. 9. Therefore, even when ink is ejected from the nozzle head 2, the distribution has the parabolic shape in which the velocity is zero in the outer periphery, in the vicinity of the exit of the nozzle head 2 as represented by the velocity distribution of the cross-section AA. The velocity distribution is changed so that the overall distribution approaches gradually uniform velocity as indicated in cross-sections B and C, as the ink travels from a nozzle exit 2′ toward the traveling direction. In this example, because the velocity of the ink in the outer periphery is close to zero, the velocity of the capillary waves that propagate on the surface is close to zero. Under the circumstances, because the capillary waves are not amplified as described above, a distance (breakup distance) from the nozzle exit 2′ until the droplet is broken up is longer, and a breakup position is out of the exit of the charging electrodes 3 and 8 located in the exit of the nozzle as illustrated in FIG. 8. Therefore, the breakup droplets are not sufficiently charged, resulting in a problem that print distortion (error in landing position on the print body 16) becomes large.

On the contrary, in the first embodiment of the present invention, because the axis vicinity velocity suppression unit 17 is located within the ink chamber 1, as illustrated in FIG. 2, after the ink within the ink chamber 1 first travels as indicated by velocity vectors 18, the ink is squeezed by the outer periphery of the axis vicinity velocity suppression unit 17 as indicated by velocity vectors 19 so as to increase in velocity and deflect, and is then squeezed inward as indicated by velocity vectors 20. In this situation, because the velocity in the vicinity of the center axis is low as indicated by a velocity vector 21, the velocity distribution within a nozzle straight pipe 2″ has a concave type velocity distribution in which the velocity in the vicinity of the center axis (ink incident line 1′) is lower than that in the periphery as indicated by a cross-section D in FIG. 3. Therefore, the velocity distribution in the exit of the nozzle exit 2′ has the concave type velocity distribution as indicated in the cross-section A. In the case of the concave type velocity distribution, because a high speed region is present on the outside rather than the center axis, and close to the outer periphery, the velocity of the surface of the liquid column ejected from the nozzle exit 2′ quickly reaches a given uniform velocity, as a result of which the breakup distance is shortened, and the liquid column is surely broken up within the charging electrodes 3 and 8. For that reason, there are advantages that the charging of the droplets is sufficiently properly conducted, and the ink jet printer small in the print distortion and stable in the print performance can be provided.

As described above, in the first embodiment of the present invention, with the provision of the axis vicinity speed suppression unit 17, the velocity of the surface of the liquid column ejected from the nozzle exit quickly reaches the given uniform velocity, as a result of which because the cutoff into the droplets is conducted within the charging electrodes at a short distance, and the charging of the droplets is sufficiently properly conducted, there is an advantage in that the ink jet printer small in the print distortion can be provided.

In this example, it is needless to say that the axis vicinity speed suppression unit 17 is supported to the nozzle head 2 by a radial support member (not shown). FIG. 4 illustrates an example of support means 17′ for the axis vicinity speed suppression unit 17. Also, as a dimension of a diameter of the nozzle exit 2′, for example, about 0.1 mm is preferable. Also, it is preferable that an interval between the electrodes 5 and 11 is about 3 mm. Also, it is desirable that a distance between the end of the axis vicinity speed suppression unit 17 close to the nozzle exit 2′ and the nozzle exit 2′ is within 30 times of the diameter of the nozzle exit 2′.

Also, in the example of FIG. 1, a left side of the figure is described as the ground deflection electrode 5, and a right side thereof is described as the high voltage deflection electrode 11. However, the voltage to be applied to those deflection electrodes may be reversed, that is, the high deflection electrode 11 may be grounded, and the deflection electrode 5 may be negative voltage. Also, if the ink droplets are positively charged, it is needless to say that the voltage of the deflection electrodes is reversed in positive and negative.

Also, an electric field shield member 10 is installed between the charging electrodes 3, 8 and the deflection electrodes 5, 11 for the purpose of blocking an influence of the electric field from the high voltage deflection electrode 11. The electric field shield member 10 is formed of a conductive member, and it is preferable that the electric field shield member 10 is grounded so that the charging electrodes 3 and 8, and the periphery thereof are not affected by the electric field developed by the high voltage, also as illustrated in FIG. 1.

As described above, according to the first embodiment of the present invention, the ink jet recording apparatus that can perform high velocity printing which is small in printing distortion can be realized.

### Second Embodiment

Subsequently, a second embodiment of the present invention will be described.

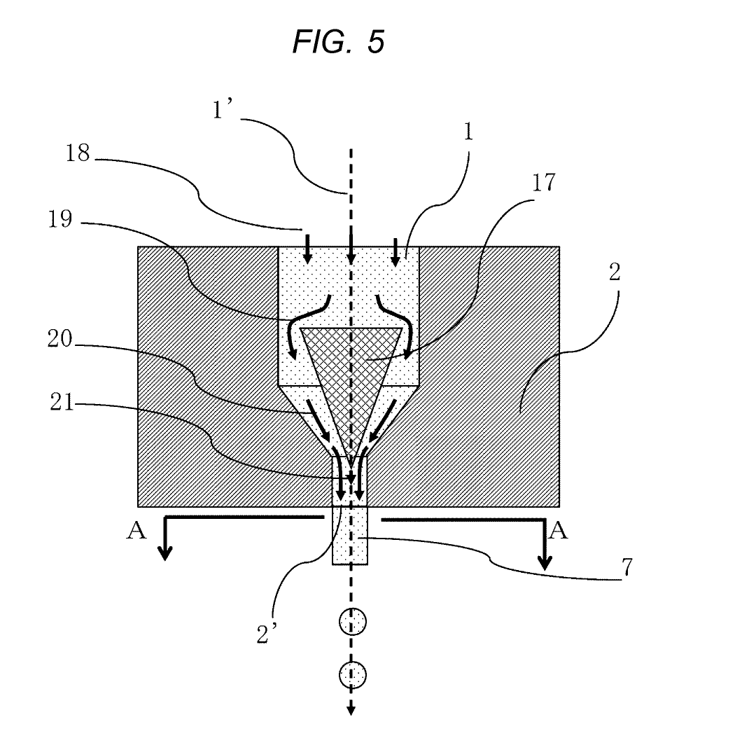

FIG. 5 is a configuration diagram illustrating a main portion of a second embodiment of the present invention. The other configurations not illustrated in FIG. 5 are equivalent to those in the example of FIG. 1. Referring to FIG. 5, the axis vicinity speed suppression unit 17 is formed in a conical shape a cross-sectional area of which decreases in a traveling direction. With this configuration, since a protruding end of the cone is brought close to the nozzle exit 2′, a concave type velocity distribution with a reduction in a velocity in the vicinity of the center axis can be generated, and the breakup distance can be shortened.

### Third Embodiment

Subsequently, a third embodiment of the present invention will be described.

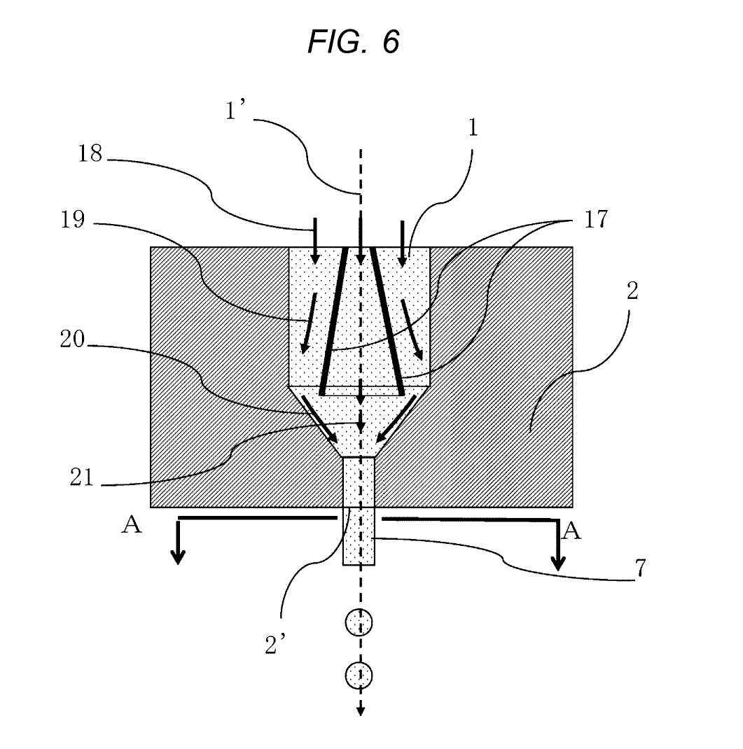

FIG. 6 is a configuration diagram illustrating a main portion of a third embodiment of the present invention. The other configurations not illustrated in FIG. 6 are equivalent to those in the example of FIG. 1. Referring to FIG. 6, the axis vicinity speed suppression unit 17 is of a double pipe structure in which a flow of ink is diverged into an inside and an outside. On the exit, a velocity of the inside is lower than a velocity of the outside. The velocity distribution is obtained by making a cross-sectional area ratio of the outside to the inside in the double pipes smaller at an entrance thereof, and larger at the exit.

With the above configuration, since the velocity distribution can be controlled by selection of diameters of the inside and the outside of the double pipes, there is an advantage in that the cutting distance suitable for the ink characteristics can be easily designed.

### Fourth Embodiment

Subsequently, a fourth embodiment of the present invention will be described.

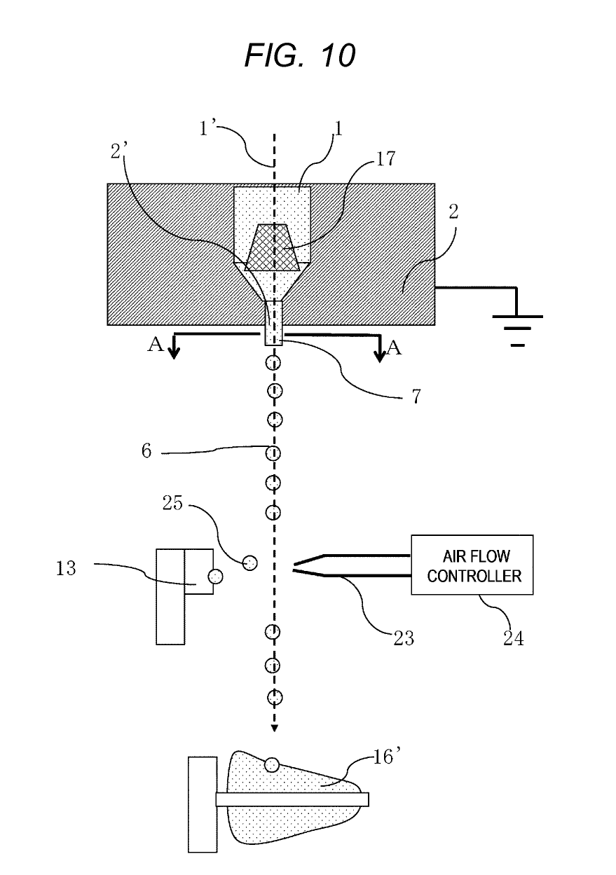

FIG. 10 is a configuration diagram illustrating a main portion of a fourth embodiment of the present invention. Referring to FIG. 10, reference numeral 16′ denotes a 3D printing production. This embodiment shows an example in which droplets are not charged. The droplets 6 discharged from the nozzle exit 2′ form a droplet string as illustrated in the figure. An air flow nozzle 23 is installed in a space where the droplets reach the 3D printing production 16′, and a high-speed air flow is intermittently discharged from the air flow nozzle 23 so as to collide with the droplets 6, and droplets 25 not required in the 3D printing is blown, and recovered by the gutter 13. The discharge of the air flow from the air flow nozzle 23 is controlled by an air flow controller 24.

With the above configuration, there is an advantage in that the 3D printing can be prepared by ink containing various materials therein.

1. An ink jet recording apparatus for recording characters on an object to be recorded which relatively moves in a direction substantially perpendicular to an ejection direction, including a unit that injects ink droplets, and a unit that generates a recording signal corresponding to recording information, comprising:
an axis vicinity velocity suppression unit disposed on a center axis of the unit that injects the ink droplets, the ink droplets having equal volume.

2. The ink jet recording apparatus according to claim 1,
wherein the axis vicinity velocity suppression unit includes an object having a cross-sectional area increased toward a travel direction, which is located within a nozzle.

3. The ink jet recording apparatus according to claim 1,
wherein the axis vicinity velocity suppression unit includes an object having a cross-sectional area decreased toward a travel direction, which is located within a nozzle.

4. The ink jet recording apparatus according to claim 1,
wherein the axis vicinity velocity suppression unit includes a double pipe that radially diverges a flow into an inside and an outside, and reduces a velocity of the inside more than a velocity of the outside.

5. The ink jet recording apparatus according to claim 1, wherein a distance between an end of the axis vicinity velocity suppression unit close to a nozzle exit, and the nozzle exit is within 30 times of a diameter of the nozzle exit.
